(19) United States
(12) Patent Application Publication
(10) Pub. No.: US 2013/0108189 A1
(43) Pub. Date: May 2, 2013

(54) Method for Manufacturing Sterile Flexible Bags Filled with a Product, Particularly with a Therapeutic Liquid, and Corresponding Bags

(71) Applicants: Philippe Lejeune, Quimper (FR); Philippe Macquet, Quimper (FR)

(72) Inventors: Philippe Lejeune, Quimper (FR); Philippe Macquet, Quimper (FR)

(73) Assignee: HEMA, Quimper (FR)

(21) Appl. No.: 13/582,514

(22) PCT Filed: Mar. 7, 2011
(86) PCT No.: PCT/EP11/53398

§ 371 Date: Jan. 11, 2013

(30) Foreign Application Priority Data
Mar. 5, 2010 (FR) 1051641

(51) Int. Cl. B31B 1/64; B65D 33/00

(52) U.S. Cl. CPC B31B 1/64; B65D 33/00
USPC 383/41; 493/189

(57) ABSTRACT

A method for manufacturing sterile flexible bags filled with a filling product and provided with a valve, including a) a step of placing valves on a first flexible film and sterilizing at least one of the two surfaces of the first film, b) a step of forming bags by heat welding from at least the first film, and filling the bags with a filling product. The valves each include a base applied directly onto the first film, and a tube assembled via an open end onto base in order to cover a tapping area of the base, the tube having a removable portion intended to be removed to uncover the tapping area and allow the product to be withdrawn by poking a needle into the area.

### BACKGROUND

This invention relates to a method of manufacturing sterile flexible bags filled with a filling product, as well as a corresponding manufacturing device. This invention relates to in particular a method and a device of manufacturing so-called perfusion bags comprising a therapeutic liquid.

Perfusion bags are used to administer to patients various types of therapeutic liquids. These bags are manufactured conventionally by molding and have one or two openings for their filling and for subsequently withdrawing the liquid by means of a perfusion needle. The bags can include a first opening for their filling, which is sealed, for example by means of a cap after filling, and a second opening closed by a valve comprising a membrane wherein the perfusion needle is inserted in order to withdraw the liquid.

After filling, the bags must be sterilized by passing through an autoclave at 120° C. This operation of sterilization after filling is long and tedious to implement. The bags, as well as the closing systems and/or membrane valve systems must be made of high temperature resistant materials.

Moreover, this passage in the autoclave prohibits the use of flexible bags for many therapeutic products which cannot withstand such a rise in temperature, in particular products containing vitamins, proteins, sugars and/or certain active ingredients. To date, these products can be administered only by means of rigid glass bottles, of which the interior wall can be sterilized before filling the bottle, generally by chemical means, in particular with peracetic acid or oxygenated water. The use of flexible bags for administrating therapeutic products as such remains relatively limited.

### SUMMARY OF THE INVENTION

The purpose of this invention is to propose a solution aimed at overcoming the aforementioned disadvantages.

To this effect, this invention proposes a method of manufacturing sterile flexible bags filled with a filling product, in particular perfusion bags comprising a therapeutic liquid, each bag including two sheets connected together over their entire periphery in order to define an interior volume and being provided with a valve making it possible to withdraw the product from the bag, characterized in that it comprises

a) a step of placing valves, for example at a regular interval, on a first flexible film and of sterilizing at least one of the two faces of said first film, said sterilization being carried out by electron beam,

b) a step of forming bags by heat welding using at least said first film in such a way that the interior volume of the bags is delimited by a face or faces of film sterilized beforehand by electron beams, and of filling said bags with a filling product.

According to the invention, sterilization is carried out by electron beam of the film or films that comprise the bags before the forming of the bags, in such a way that the faces of the film or films that delimit the interior volume of the bags are sterilized. As such, the interior volume of the bags is sterile and the filling product can be loaded into the bags, without required later sterilization.

Sterilization by electron beam of the film or films guarantees an effective and fast sterilization of the bags, and does not leave any residual traces after treatment.

The method according to the invention does not require any sterilization by autoclave, and as such makes it possible to use perfusion bags for many temperature-sensitive therapeutic products, which were until now packaged in glass bottles, with the manufacturing costs of bags sterilized and filled according to the invention, as well as the transport and storage costs being less than those of sterilized and filled glass bottles.

Moreover, suppressing a step of sterilization by autoclave makes it possible to use a large variety of films for carrying out the bags, thinner and less expensive, as well as a greater variety of valves, in particular a valve system of the same type as that described in U.S. Pat. No. 7,032,631.

The suppression of this step of sterilization by autoclave further makes it possible to propose a method for carrying out sterile and filled bags that is faster, while still remaining simple in terms of design and implementation.

According to an embodiment, the step a) comprises the sterilization of the two faces of said first film.

According to an embodiment, the valves are sterilized with the film or films, the step a) comprises the placing of valves on the first film, then the sterilization by electron beam of the first film provided with valves. Alternatively, the valves are sterilized separately before their placing, the first film then able to be sterilized before the placing of the valves.

According to an embodiment, the step a) comprises the sterilization of at least one face of a first film and of at least one face of a second film, the step b) of forming comprising the heat welding of the first film with the second film. Alternatively, the bags are carried out using a single film, said film being folded in two, more preferably after sterilization.

According to a first embodiment, the step b) comprises the forming of bags then the filling of bags by said valves with a filling product.

According to a second embodiment, the step b) comprises a pre-forming of the film or films in order to former a tubular sleeve arranged substantially vertically, the filling of said sleeve via its open upper side, and the final forming of the bags filled by carrying out transversal heat welds.

According to an embodiment, the valves placed in the step a) each include a tubular base provided with a membrane.

Alternatively, the valve is of the connector type, the filling being able to be carried out by means of a male end fitting inserted into said connector.

According to another alternative, the valves placed in the step a) each include a base, formed of a mass of product, applied directly onto the first film, a needle able to be pricked through said mass and the film for the filling of the bag, and a tube assembled, for example via insertion, by an open end onto said base in order to cover a tapping area of the base, said tube having a breakable portion intended to be removed in order to uncover said tapping area and making it possible to withdraw the product by pricking a needle into said tapping area.

According to an embodiment, the step of filling a bag includes the piercing of the valve, in particular of a membrane of the valve, by a needle and the filling of the bag via said needle.

According to an embodiment, the step of filling is followed by a step c) of closing the through hole of the needle formed in the valves, in particular their membrane, in the step of filling, for example by welding membranes of the valves, in particular by laser welding, or by depositing wax or resin.

More preferably, the step of sterilizing is carried out in a protective chamber making it possible to prevent the propagation of radiation. More preferably, the step of sterilizing, the step of forming and/or the step of filling are carried out in a sterile chamber.

According to an embodiment, the step of forming includes the forming of at least one chain of bags using one or two films, each bag comprising two sheets connected along two longitudinal welds and two transversal welds, with two successive bags in the chain connected to one another along transversal welds.

This invention also has for purpose a device of manufacturing sterile flexible bags filled with a filling product, in particular perfusion bags comprising a therapeutic liquid, for the implementation of the method defined hereinabove, with each bag comprising two sheets connected together over their entire periphery in order to define an interior volume and being provided with a valve making it possible to withdraw product from the bag, characterized in that it comprises
means of placing valves on a first flexible film;
means of sterilization via electron beams of at least one of the two faces of said first film,
means for forming bags by heat welding using at least said first film, in such a way that the interior volume of the bags is delimited by one face or faces of film sterilized beforehand by electron beams, and
means for filling with a filling product of bags formed or partially formed.

According to an embodiment, said means of sterilization include at least two electron beam emitters between which pass said first film in order to treat the two faces of said first film, said means of sterilization being more preferably arranged downstream of said means of placing, in such a way that said valves are also treated exteriorly by electron beams during the passing of the film between the two emitters.

This invention also has for purpose a sterile flexible bag filled with a filling product, in particular a perfusion bag comprising a therapeutic liquid, said bag comprising two sheets connected together over their entire periphery and being provided with a valve making it possible to withdraw product from the bag, characterized in that said valve comprises a base applied directly on a sheet of the bag, and a tube assembled via an open end onto said base in order to cover a tapping area of the base, said tube having a removable portion intended to be removed in order to uncover said tapping area and to make it possible to withdraw product by pricking a needle into said tapping area.

According to a particularity, the base of said valve is formed of a mass of product that is more preferably flexible, for example thermo-welded onto a sheet.

According to an embodiment, said removable portion is a breakable portion defined for example by an incipient fracture.

According to an embodiment, said removable portion is formed of a removable cap, for example screwed onto the tube.

According to an embodiment, said tube of the valve is provided with means for blocking able to cooperate, after removal of the removable portion, with complementary means for blocking of a needle, for the blocking of the needle on said valve in order to withdraw product contained in the bag.

According to an embodiment, the means for blocking include a snap-fitting element, for example on a tubular wall of the tube, said complementary means for blocking include a cap of which the needle passes through the bottom, the lateral wall of the cap of the needle comprising a complementary snap-fitting element able to cooperate with the snap-fitting element of the tube, the snap-fitting element and the complementary snap-fitting element being for example formed respectively of a collar and of a groove, or inversely. Advantageously, when the needle is blocked on the tube, said cap of the needle closes in a substantially sealed manner the tube of the valve.

This invention also has for purpose a needle provided with such complementary means for blocking.

### BRIEF DESCRIPTION OF THE DRAWINGS

The invention shall be better understood, and other purposes, details, characteristics and advantages shall appear more clearly in the following detailed explanatory description of currently preferred particular embodiments of the invention, in reference to the annexed diagrammatical drawings, wherein:

FIG. 1 is a diagrammatical view of a device for treating according to a first embodiment;

FIG. 2 is a diagrammatical view of a device for treating according to a second embodiment of the invention;

FIG. 3 is a diagrammatical side view of a valve according to a first embodiment;

FIG. 4 is a partial diagrammatical side view of a bag provided with a valve according to a second embodiment;

FIG. 5 is a diagrammatical view analogous to that of FIG. 4, after removal of the removable portion of the valve, for the setting into place of a perfusion needle;

FIG. 6 is a partial cross-section view of the bag of FIG. 4, provided with a perfusion needle;

FIG. 7 is a partial diagrammatical side view of a bag provided with a valve according to a third embodiment;

FIG. 8 is a partial cross-section view of the bag of FIG. 7; and,

FIG. 9 is a view analogous to that of FIG. 8, after removal of its removable portion and setting in place of a perfusion needle.

### DETAILED DESCRIPTION OF THE PREFERRED EMBODIMENT(S)

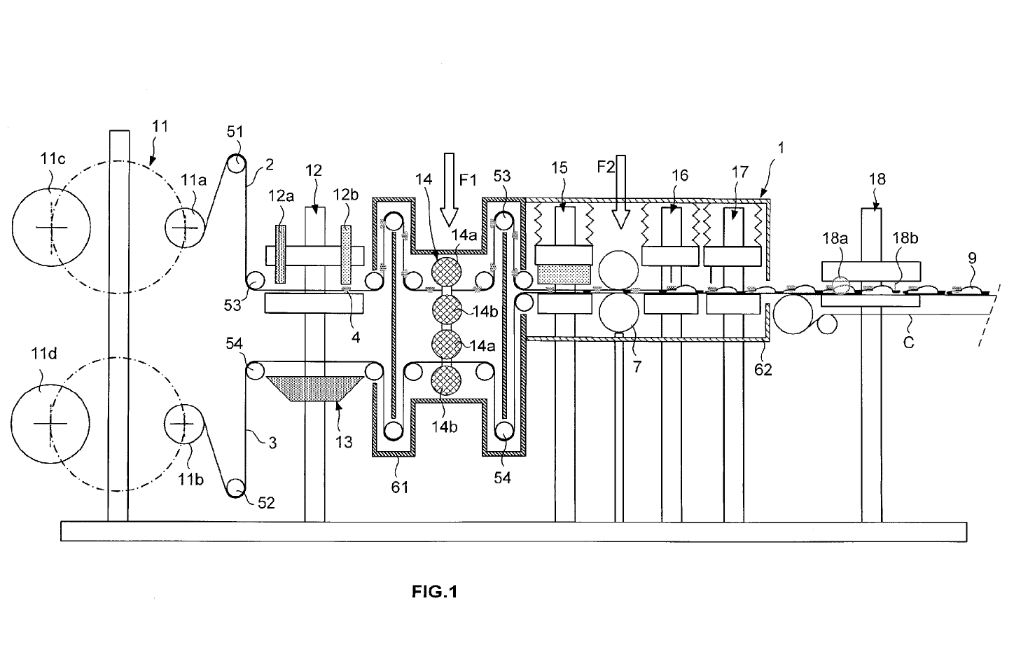

FIG. 1 shows in a diagrammatical way a device 1 according to a first embodiment for the manufacture of sterile flexible bags 9 filled with a filling product. The device makes it possible to construct bags by welding using two films 2, 3 of sterilized plastic materials. The bags are filled through a membrane valve after the full development of the bag. After filling, the membranes of the valves are re-welded and the bags are cut then evacuated outside of the device.

The device 1 of the linear type comprises from upstream to downstream in relation to the forward direction of the films:
a station 11 for unwinding reels of film;
a station 12 for placing valves for assembling valves on the first film and a station 13 for marking in order to mark the second film;
a station 14 for sterilizing with an electron beam, in order to sterilize the two faces of each film;
a station 15 for forming bags by heat welding;
a station 16 for filling in order to fill the bags with a filling product by means of a needle passing through the membranes of the valves;
a station 17 for sealing in order to seal the membranes of the valves; and,
a station 18 for cutting bags. The station 11 for unwinding comprises two locations 11a, 11b, in order to receive two reels of film during use, an upper location 11a to receive a first reel from which will be unwound a first film 2, and a lower location 11b to receive a second reel from which will be unwound a second film 3. The films are formed from a plastic material that can be heat welded, and having a webbing making it possible to make one or several bags in the webbing. More preferably, the station for unwinding further comprises two additional locations 11c, 11d for the unloading of empty reels and the loading full reels. Each location comprises a roller, more preferably motorized whereon is mounted a reel of film. A stretching system comprising rollers 51, 52 makes it possible advantageously to absorb the startings and stoppings of films in the device.

The device includes first guide rollers 53 and second guide rollers 54 making it possible to respectively guide the upper film towards the station 12 for placing, the station 14 for sterilizing and the station 15 for forming, and the second film towards the station 13 for marking, the station for sterilization and the station for forming.

At the station 12 for placing, a first tool 12a carries out cuts at regular intervals in the first film 2 and a second tool 12b makes it possible to heat seal valves on said cuts, by heat or ultrasound welding. The valves are for example formed of a rigid or semi-rigid tubular base provided with a membrane, the base is provided with a collar via which the valve is heat sealed to the first film. According to an embodiment, the valves include a membrane such as described in document U.S. Pat. No. 7,032,631.

When the first film 2 passes into station 12 for placing valves, the second film 3 passes into the station 13 for marking arranged under the station 12 for placing valves. At this station for marking, a marking is carried out by laser or ink jet on the lower face of the second film, the marking can include for example the lot number and the expiration date. At the output of the station for placing valves and of the station for marking, the first film and the second film pass into the station 14 for sterilizing by electron beams. The lower face of the first film and the upper face of the second film are intended to former the internal faces of the bags delimiting the interior volume of the bags. The upper face of the first film whereon have been assembled the valves, and the lower face of the second film are intended to former the exterior faces of the bags. The station for sterilization makes it possible to sterilize at least the lower face of the first film and the upper face of the second film, and at least the upper face of the first film, in order to sterilize the exterior side of the valves. In the embodiment shown, each film 2, 3 passes between two emitters 14a, 14b arranged transversally to the forward direction of the films, in such a way that the two faces of each film are sterilized. The station for sterilization as such comprises four electron beam emitters, for example formed by emitters commercialized by the company AEB. The devices comprises a control screen making it possible to adjust and to control the sterilization parameters, in particular the voltage and the intensity of the emitters as well as the exposure time to the electron beams defined by the forward speed of the film. This sterilization by electron beams makes it possible to obtain very high levels of sterilization, from Log 3 to Log 6.

The sterilization is carried out in a protective or shielding chamber 61, formed of lead walls, in order to stop the radiation emitted by the emitters, in particular the spurious radiation of the X-ray type. Such as shown in FIG. 1, each film is guided according to a U-shaped path at the inlet and at the outlet of the protective chamber in order to prevent any propagation of radiation outside of the chamber, via reflection and/or diffusion on the lead walls. This protective chamber is also used as a sterile chamber wherein a flow Fl of sterile air is injected.

At the output of the protective chamber, the films 2, 3 are brought close to each other by guide rollers 53, 54 in order to enter the station 15 for forming, wherein the bags are formed by heat welding of the first film with the second film. Each bag is carried out by longitudinal welds and transversal welds. Each bag is formed of two sheets, constituted of a portion of the first film and of a portion of the second film, and connected together over their entire periphery by heat welding in order to define an interior volume. Each bag is provided with a valve making possible here the filling of the bag and the withdrawing of the product from the bag.

The station for forming makes it possible to carry out heat welds or welded via ultrasound, formed of the welding electrode and of the welding counter-electrode defining the shape of the bags.

The chain of bags formed at the output of the station for forming passes into the station 16 for filling.

A system 7 for driving is inserted between the station for forming and the station for filling in order to drive step-by-step the films through the various stations of the device, this system for driving comprises two rollers between which pass the chain of bags. At least one of the two rollers is motorized, with the motorization able to be provided by a servomotor. If the second film is printed, markings read by cells can control the advancing of the films.

At the station 16 for filling, the filling of each bag with a filling product is carried out thanks to a needle which pierces the membrane of the valve which is welded onto the first film.

The holes for the passing of the needles in the membranes are then closed at the station 17 for sealing, in order to ensure the seal of the bag and prevent any contamination of the product. By way of example, the through hole is closed by laser welding. Alternatively, the through hole is resinous, with a drop of resin being deposited on the membrane.

The station 15 for forming, the system 7 for driving, the station 16 for filling and the station 17 for sealing are placed in a sterile chamber 62 wherein is injected a flow F2 of sterile air.

The device advantageously includes a system for overpressuring sterile air comprising filters which sterilize the air and pumps which provide an overpressure of sterile air in the chambers 61, 62. Advantageously, the overpressure in the protective chamber 61 is greater than the overpressure in the sterile chamber 62.

At the output of the station for filling, the chain of bags is received on the upper strand of a conveyor C along which is arranged the station 18 for cutting in order to separate by cutting the bags from each other. If several bags are formed in the width of the films, a first cutting tool 18a provides the longitudinal cut or cuts. A second cutting tool 18b provides the transversal cut. The bags are cut according to the shape desired, a hole able to be made in a welded area of the two films in order to provide for the hanging during later use.

At the output of the station for cutting, the bags are evacuated towards a system for packaging.

The system advantageously includes a sterilization system making it possible to sterilize the various stations by hot air, for example with hot air at 260° C. in order to reach 160° C. on the faces to sterilize. Moreover, a sterilization system is advantageously provided to sterilize in place the filling circuits with water vapor, for example at 140° C. and 3.5 bars.

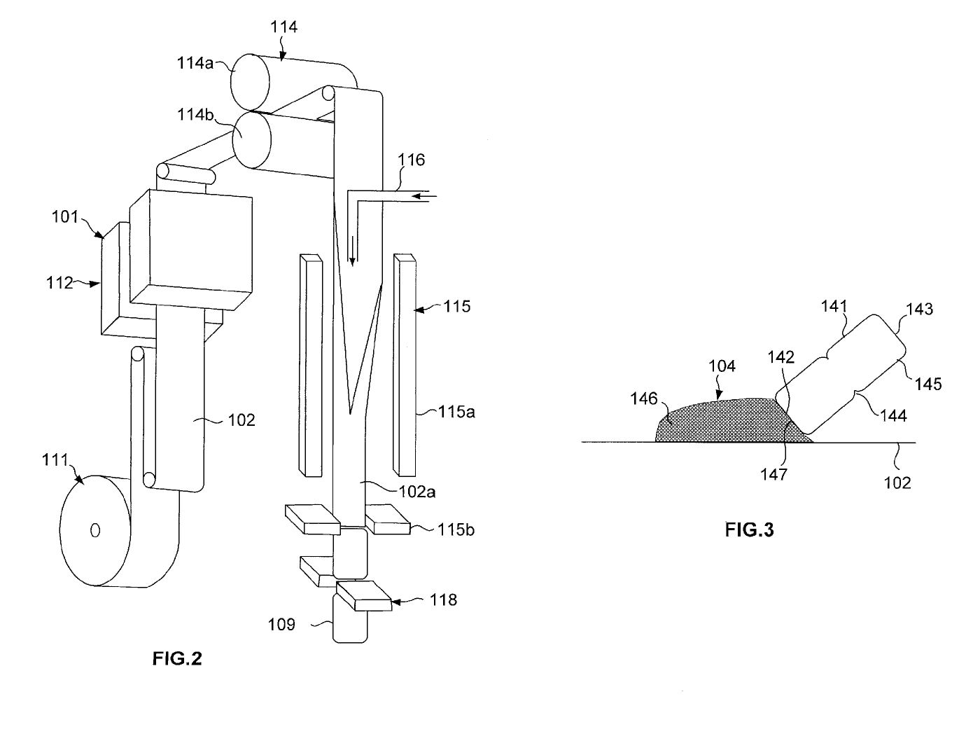

FIG. 2 diagrammatically shows a device 101 for manufacturing bags according to a second embodiment. The device makes it possible to construct bags 109 by welding using a single film 102 made of sterilized plastic material, with the two sheets of a bag being comprised of the same film. After placing a valve and sterilization, the film is folded over itself and heat welded in order to form a tubular sleeve or tube 102a extending substantially vertically, the tube is filled to a constant level by its upper end, then is closed by welding and cut in order to form the bags. The device 101 includes:
a station 111 for unwinding receiving a single reel from which is unwound a film 102;
a station 112 for placing valves in order to assemble valves on the film;
a station 114 for sterilizing with an electron beam, comprising two emitters 114a, 114b of electron beams between which pass the film in order to sterilize the two faces of the film as well as the valves;
a station 115 for forming bags by heat welding comprising first means 115a making it possible to progressively fold the film in order to bring the two longitudinal edges of the film together and to heat weld the two longitudinal edges together in order to form a tube 102a, and second means 115b for forming in order to carry out transversal heat welds on the tube in order to form the bags 109;
a station 116 for filling in order to fill the tube to a constant level with a filling product via its open upper end; and
a station 118 for cutting bags downstream of the second means 115b for forming.

The station 112 for placing makes possible for example the placing of a valve such as is shown in FIG. 3. The valve 104 comprises a connector or tube 141 made of plastic material comprising an open end 142 and a closed end 143. The tubular wall is provided with an incipient fracture 144 defining a breakable portion 145 which comprises said closed end. This tube is assembled on the film by means of a base 146 formed of a mass of product whereon is assembled the tube via its open end, said base being welded directly onto the film 102.

In order to withdraw the product, the breakable portion 145 is removed in order to uncover a sterile tapping area 147 of the base, and a perfusion needle can then be pricked through said base 146 and the film 102. This valve makes it possible to withdraw the liquid with a needle which pierces the bag in a sterile area. This valve as such makes it possible to suppress the risk of pollution of the liquid withdrawn during the piercing of the bag by the needle of the final user. The tube 141 is advantageously sterilized by gamma rays before welding on the film.

Alternatively, the valve 104 shown in FIG. 3 is used in the device of FIG. 1, the base 146 is welded onto the first film, without carrying out cutting beforehand, and the filling is carried out by piercing through the base 146 and the film 2 by means of a hollow needle, the hole of the needle being more preferably sealed by welding, such as described hereinabove.

Alternatively the means 115b for forming further make it possible to carry out one or several thermo-longitudinal welds, in such a way as to form several bags side-to-side in the width of the same sleeve.

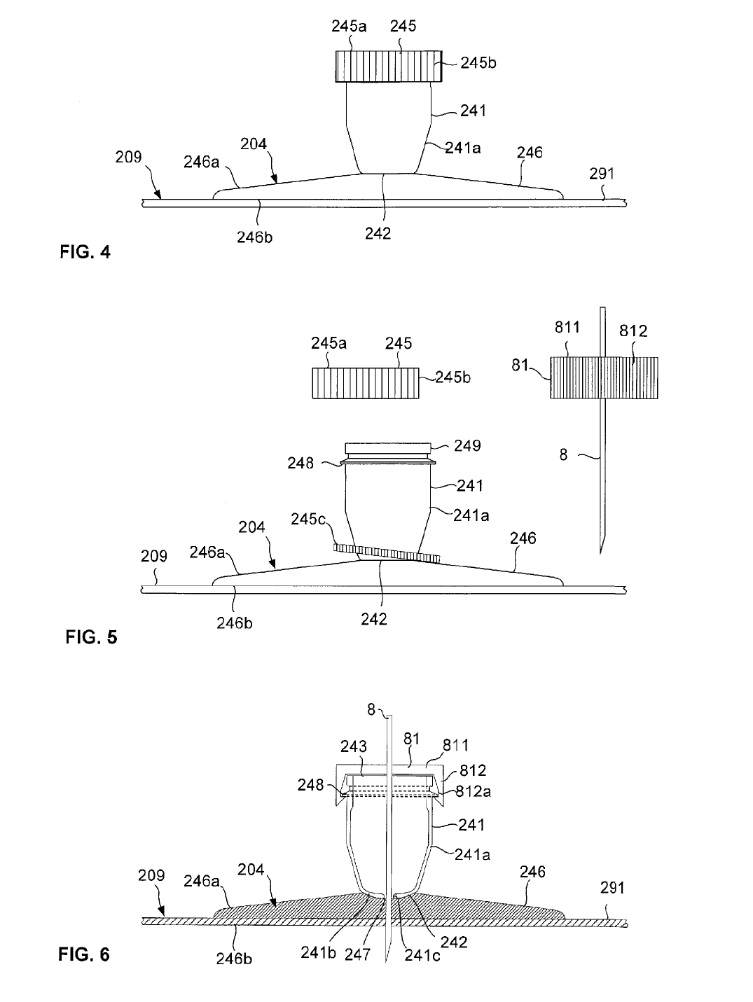

FIGS. 4 to 6 show a valve 204 according to a second embodiment comprising as previously a tube 241 and a base 246.

The tube comprises a tubular wall 241a with a first open end 242 and a second open end 243, At this first end 242, the tubular wall is in part closed by a lower wall 241b provided with an axial opening 241c, as can be seen in FIG. 6. The second open end 243 is closed in a substantially sealed manner by a removable portion, constituted here of a cap 245. The cap is of the screw cap type, and comprises a shell or cover comprising a bottom 245a and a lateral wall 245b. The internal face of its lateral wall is provided with a threading for the screwing of the cap onto the upper portion 249 of the tubular wall of the tube which is provided exteriorly with a corresponding threading (not shown). Alternatively, the cap is assembled by snap-fitting.

The base 246 is formed of a mass of flexible product, having here the form of a layer. The tube 241 is assembled via its first open end 242 onto the upper face 246a of the base 246, the lower wall 241b of the tube coming against said upper face 246a of the base. The base has a lower face 246b substantially plane via which the valve is assembled onto one 291 of the sheets of the bag 209.

The tube is made of a rigid plastic material, for example of thermoplastic material, such as a polypropylene or a polyethylene terephtalate. The base is for example made of a flexible thermoplastic material, such as a polyamide. The manufacture of the valve is for example carried out via overmolding of the base 246 on the tube 241.

The valves provided with their cap are more preferably sterilized by gamma rays before being assembled on a film by heat welding, by arranging the substantially planar lower face 246b of the bases against said film.

In order to withdraw the product, the cap 245 of the valve 204 is unscrewed from the tube in order to uncover the sterile tapping area 247 of the base that can be accessed from the opening 241c, and a perfusion needle 8 can then be pricked through said base 246 and the sheet 291 of the bag 209, such as is shown in FIG. 6.

The cap of the valve is advantageously provided with a tamper proof ring 245c which can be separated from the cap, such as shown diagrammatically in FIG. 5, as such allowing the user to check that the sterility has not been compromised before use.

The valve 204 advantageously includes means for blocking cooperating with complementary means for blocking the needle in order to block the needle on the valve. By way of example, these means for blocking include an external collar 248 arranged in the tubular wall 241a of the tube, below the aforementioned upper portion 249 provided with the threading. The complementary means for blocking have the form of a cap 81 comprising a bottom 811 and a lateral wall 812, the hollow rod of the needle passing axially through the bottom of the cap. The needle is more preferably mounted in a fixed manner on said fond. The internal face of the lateral wall has an annular groove 812a wherein the collar 248 is able to be snap-fitted in order to block the cap on the tube. In order to facilitate this operation of snap fitting, mainly by elastic deformation of the lateral wall of the cap, the free end edge of the tubular wall and the upper face of the collar are inclined. Alternatively, the snap fitting of the cap 81 on the valve is obtained by a collar or internal rib of the cap coming to be housed in a complementary groove of the tube. When the needle 8 is mounted on the tube 241, its cap 81 comes to close the tube, which increases the level of hygienic safety inside the tube.

The cap 81 of the needle can further include a tamper proof ring (not shown) which maintains the needle in position on the bottom 811 of the cap and which separates when the needle is removed from the cap.

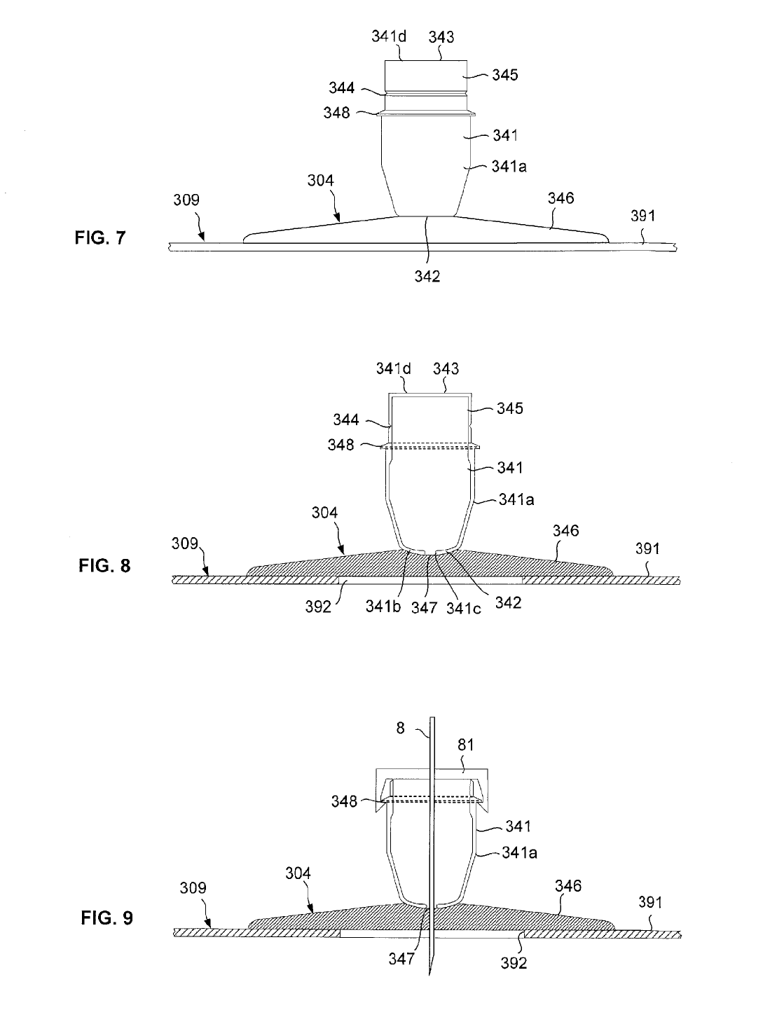

FIGS. 7 to 9 show a valve 304 according to a third embodiment further comprising a tube 341 and a base 346. The tube comprises a tubular wall 341a with a first open end 342 and a second closed end 343 via an upper wall 341d. At the first end, the tubular wall is in part closed by an end wall 341b provided with an axial opening 341c, as can be seen in FIG. 8. The tubular wall is provided with an incipient fracture 344 or weakening line, formed by an annular notch on the exterior face of the tubular wall, this incipient fracture defining a breakable portion 345 which comprises said second closed end. The tube 341 is assembled as previously onto a base 346 formed from a mass of a flexible material having substantially the form of a layer. The valve is for example carried out via overmolding of the base on the tube. Alternatively the valve is carried out via bi-injection.

In this embodiment, the valve is welded on a channel 392 of a sheet of the bag, the channels of bags being obtained by making cuts at regular intervals in a film before the operation of welding the valves, as described above. The base is welded, for example via ultrasound, around said channel, in such a way that the tube is substantially centered according to said channel.

The tube has exteriorly a collar 348 for the blocking of a needle 8 mounted on a cap 81, such as described previously.

In order to withdraw the product from the bag 309, the user breaks the tube 341 in order to remove the breakable portion 345. A perfusion needle 8 can then be prickked through said base 346, into the tapping area 347, in order to open into the bag, passing through the channel 392, such as is shown in FIG. 9.

The bags provided with valves 204 and 304 shown in FIGS. 4 to 9 can as before be obtained via
the pre-forming of one or several films in order to form a tubular sleeve arranged substantially vertically, the filling of said sleeve via its open upper side, and the final forming of the bags filled by carrying out transversal heat welds, or
the forming of the bags then the filling of the bags by said valves with a filling product, the step of filling of a bag comprising the piercing of the base of the valve and of the film by a needle and the filling of the bag via said needle, this filling being more preferably followed by a step of closing of the through hole of the needle formed in the bases of the valves in the step of filling.

Although the invention has been described in liaison with particular embodiments, it is of course evident that it is in no way limited to this and that it comprises all of the technical equivalents of the means described as well as their combinations if the latter fall within the scope of the invention.

1-15. (canceled)

16. Method of manufacturing sterile flexible bags filled with a filling product comprising a therapeutic liquid, each said bag including two sheets connected together over their entire periphery and being provided with a valve making it possible to withdraw the product from the bag, the method comprising:
a) providing valves which each include a base and a part, assembled together,
b) placing the valves by application of each base directly onto a first flexible film and wherein at least one of two faces of said first flexible film is sterilized, and
c) forming bags by heat welding using at least said first flexible film in such a way that an interior volume of the bags is delimited by a face or faces of said film sterilized beforehand, and filling said bags with a filling product, wherein:
before the placing of the valves, on the first flexible film tapping areas are defined by a needle where respectively the bases are to be applied,
during the step of providing the valves the part is carried out as a tube: having a removable portion adepted to be removed in order to allow for access of the needle through the tube to said tapping area, and for which an open end is assembled to the base, and
at the step of placing the valves, the bases are applied onto the first film at the locations of the tapping areas, by covering the tapping areas.

17. Method according to claim 16, wherein the base of said valve is formed of a mass of matter which is to be pierced in order to access the tapping area of the film and which is directly applied onto the face of the first film which, once the bag is formed, is located on an exterior side of the bag.

18. Method according to claim 17, wherein said mass of matter is welded directly onto the first film.

19. Method according to claim 16, wherein said valve is sterilized by gamma rays before said valve is placed on the first film.

20. Method according to claim 16, wherein in step b), said sterilization is carried out by electron beam.

21. Method according to claim 16, wherein the step b) comprises the sterilization of the two faces of said first film.

22. Method according to claim 16, wherein the step b) comprises the placing of valves onto the first film, and then the sterilization of the first film provided with valves.

23. Method according to claim 16, wherein the step b) comprises the sterilization of the first film, then the placing of the valves onto the first film.

24. Method according to claim 16, wherein the step b) comprises the sterilization of at least one face of a first film and of at least one face of a second film, and the step b) of forming comprising the heat welding of the first film with the second film.

25. Method according to claim 16, wherein the step c) comprises a pre-forming of the film or films in order to form a tubular sleeve arranged substantially vertically, the filling of said sleeve via an open upper side, and a final forming of the bags filled by carrying out transversal heat welds.

26. A sterile flexible bag comprising two sheets connected together over their entire periphery in order to define an internal volume filled with a filling product and being provided with a valve making possible withdrawal of the product from said volume and which comprises a base applied directly onto a sheet of the bag and assembled with a part in order to be able to cover an area of the base, wherein
the base is formed of a mass of matter through which a needle is pricked in order to access said internal volume through in addition one of the sheets,
and said part is formed as a tube assembled by an open end onto the base by covering a tapping area of the base, said tube having a removable portion adepted to be removed in order to uncover the tapping area and enable withdrawal of the product through said tapping area.

27. Bag according to claim 26, wherein the base of said valve is formed of a mass of flexible matter arranged on an exterior side of the bag.

28. Bag according to claim 26, wherein said removable portion is a breakable portion.

29. Bag according to claim 26, wherein said removable portion is formed of a removable cap.

30. Bag according to claim 26, wherein said tube of the valve is provided with means for blocking able to cooperate with complementary means for blocking of a needle for the blocking of the needle on said valve in order to withdraw the product contained in the bag.
